(19) United States
(12) Patent Application Publication
(10) Pub. No.: US 2018/0328813 A1
(43) Pub. Date: Nov. 15, 2018

(54) Method And Device For Sealing Medical Packages With Integrated Real-Time Seal Integrity Vacuum Pressure Decay Testing

(71) Applicant: Charles Webb, Solvang, CA (US)

(72) Inventor: Charles Webb, Solvang, CA (US)

(73) Assignee: Van der Stahl Scientific, Inc., Solvang, CA (US)

(21) Appl. No.: 15/593,661

(22) Filed: May 12, 2017

(51) Int. Cl. G01M 3/34

(52) U.S. Cl. CPC G01M 3/34

(57) ABSTRACT

The present invention relates to a device and method for inspecting and monitoring the seal integrity and/or seal strength of sterile medical packages, and more particularly, to a medical package sealer device having integrated vacuum decay or differential pressure testing allowing for real-time seal strength or integrity testing of each medical package sealed by the device. The present invention may also be described as a method for sealing and testing medical packages. By communicatively coupling the mass flow meter(s) to the processor of the herein disclosed device for sealing medical packages with integrated real-time seal integrity vacuum decay or differential pressure testing, each sealed package may be tested for a quantitative measure of air flow, and the quantitative measure of air flow may be recorded and stored in a searchable database, or used to provide a notification to an operator or to stop operation of the system. In this way, 100% of the medical packages sealed may be inspected for deviation from an established standard.

### BRIEF DESCRIPTION OF THE INVENTION

The present invention relates to a device and method for inspecting and monitoring the seal integrity and/or the seal strength of sterile medical packages, and more particularly, to a medical package sealer device having integrated vacuum pressure decay testing (and/or differential pressure testing) allowing for real-time seal integrity testing of each medical package sealed by the device. The present invention may also be described as a method for sealing and testing medical packages.

Medical standards dictate that there is a need to combine well-known medical package sealing technology with pressure decay (or differential pressure) testing so as to provide an opportunity for 100% package inspection, thus reducing the possibility of a package with a defective seal from ending in the sterile field or in the hands of a patient, or a practicing physician or nurse, and thus exposing the patient to a risk of infection from compromised medicine or medical equipment. By communicatively coupling the mass flow meter(s) to the processor of the herein disclosed device for sealing medical packages with integrated real-time seal integrity vacuum decay or differential pressure testing, each sealed package may be tested for a quantitative measure of air flow, and the quantitative measure of air flow may be displayed on an processor, such as an onboard microprocessor, the identified medical package failure may evoke an audible and/or visual alarm and may stop system operation, preventing the failed medical package from entering the distribution chain of sterile medical device. The herein disclosed device may also record the failure event on the system onboard memory for data purge at a later time or the system can stream data via Wi-Fi which may be recorded and stored in a searchable database. In this way, 100% of the medical packages sealed may be inspected for deviation from an established standard to assure that the medical device package will not fail during sterilization or distribution.

### CROSS-REFERENCES TO RELATED APPLICATIONS

Not applicable.

### STATEMENTS AS TO THE RIGHTS TO INVENTIONS MADE UNDER FEDERALLY SPONSORED RESEARCH OR DEVELOPMENT

Not applicable.

### REFERENCE TO A “SEQUENCE LISTING,” A TABLE, OR A COMPUTER PROGRAM LISTING APPENDIX SUBMITTED ON A COMPACT DISK

Not applicable.

### BACKGROUND OF THE INVENTION

The present invention relates to a device and method for inspecting and monitoring the seal integrity and/or seal strength of sterile medical packages, and more particularly, to a medical package sealer device having integrated vacuum decay or differential pressure testing allowing for real-time seal integrity testing of each medical package sealed by the device.

The basics of medical sealer devices are well known. Generally, medical sealers (as these devices are known) require four basic components: a solenoid or pneumatic piston for applying pressure, a thermoformed tray holding fixture for holding the medical package, a heating die (or platen) for heat treating he package material, and a processor for controlling the mechanical components and for communicating with other devices (or with the internet). Medical sealer devices operate as follows. A Tyvek lid stock is heated by the heating die/platen and thermally bonded to the preformed thermoformed tray creating a sealed medical device tray package.

Packages sealed by medical sealers must meet government standards as well as other third party regulator accreditation bodies (such as ISO, International Organization for Standardization) and, therefore, the seal integrity of packages must be routinely tested during production. There are various tests for inspecting seal integrity, including peel testing, visual testing, pressure decay testing, and burst testing.

Peel testing is a way to determine seal strength utilizing destructive methodology. Peel testing measures the strength of the seal in pounds. Peel testing can only test samples pulled from the production line. But because peel testing is destructive, peel testing cannot verify the integrity of a particular medical package that is intended to be sold, and furthermore, peel testing utilizes only a 1-inch sample for testing and therefore does not evaluate the entire sealed area, but rather a representative sample only. Peel testing, therefore, cannot be utilized to perform real-time testing of 100% of the medical packages being sealed on a medical sealer device. Burst testing, an alternative destructive testing methodology, is currently utilized; but burst testing requires a great deal of time as the device tray must be prepped with specific fixtures and fittings, and so it is not an efficient method of testing 100% of packages.

Visual testing analyses seal integrity for pleating, cracking, bubbling, etc., and so differs from peel testing or burst testing in that visual testing is not a destructive methodology. But visual testing requires light and a video camera and cannot reveal the strength of the lids bonded to the thermoformed tray, and so visual testing is not generally available as a seal integrity test in real-time during production. Known visual testing for seal integrity involves removing the medical package from the production line after the seal has been sealed, and then visually testing the seal. Visual testing, therefore, cannot be utilized for performing real-time testing of 100% of the medical packages being sealed on a medical sealer device.

Pressure decay testing, also referred to as pressure decay leak testing, involves creating a closed space around a test item (this closed space is referred to as a surrogate chamber) and pressurizing it (or evacuating it) to create a pressure differential between the surrogate chamber and the sealed portion of the medical package. Once the setup is stabilized, air movement from the higher pressure area (surrogate chamber) to the lower pressure area (sealed medical package) indicates the presence of a leak path, and thus provides a quantitative measure of the seal integrity without disrupting the package tray seals. Pressure decay testing is currently in use for testing medical packaging, but it is currently utilized to test samples pulled from a production line.

There is a need, therefore, to combine well-known medical package sealing technology with pressure decay testing so as to provide an opportunity for 100% package seal strength and integrity testing, thus reducing the possibility of a package with a defective seal from ending up in the hands of a patient, or a practicing physician or nurse, and thus exposing the patient to a risk of infection from compromised medical equipment.

### BRIEF DESCRIPTION OF THE SEVERAL VIEWS OF THE DRAWING

FIG. 1 illustrates a general overview of an exemplary embodiment of a device for sealing medical packages with integrated real-time seal integrity vacuum pressure decay testing in accordance with the present invention;

FIG. 2 illustrates an isometric view of an exemplary embodiment of a device for sealing medical packages with integrated real-time seal integrity vacuum pressure decay testing as the medical packages and the packaging material are loaded into the device, in accordance with the present invention;

FIG. 3 illustrates a side view of an exemplary embodiment of a device for sealing medical packages with integrated real-time seal integrity vacuum pressure decay testing as the medical packages and the packaging material are loaded into the device, and wherein interior structure, including a heating element and a plurality of mass flow meters comprising a pressure decay leak testing apparatus, is shown in broken lines, in accordance with the present invention;

FIG. 4 illustrates a side view of an exemplary embodiment of a device for sealing medical packages with integrated real-time seal integrity vacuum pressure decay testing wherein interior structure, including a heating element and a plurality of mass flow meters comprising a pressure decay leak testing apparatus, is shown in broken lines, in accordance with the present invention;

FIG. 5 illustrates a side view of an exemplary embodiment of a device for sealing medical packages with integrated real-time seal integrity vacuum pressure decay after the medical packages have been sealed and while the medical packages are being pressure decay leak tested, wherein interior structure, including a heating element and a plurality of mass flow meters comprising a pressure decay leak testing apparatus, is shown in broken lines, in accordance with the present invention.

### DETAILED DESCRIPTION OF THE INVENTION

The present invention relates to a device and method for inspecting and monitoring the seal integrity of sterile medical packages, and more particularly, to a medical package sealer device having integrated vacuum pressure decay testing allowing for real-time seal integrity testing of each medical package sealed by the device.

Throughout this specification, the phrase “seal integrity” is used to refer to an integrity of the seal and/or the strength of the seal, and is intended to include testing for a seal integrity, testing for a strength of the seal, or both. Also throughout this specification, the phrase vacuum pressure decay is used to refer to vacuum decay testing as well as differential pressure testing of the medical packages. The phrase “medical packages” is intended to include any type of medical package, including a medical tray package of the type usually sealed by a tray sealer device.

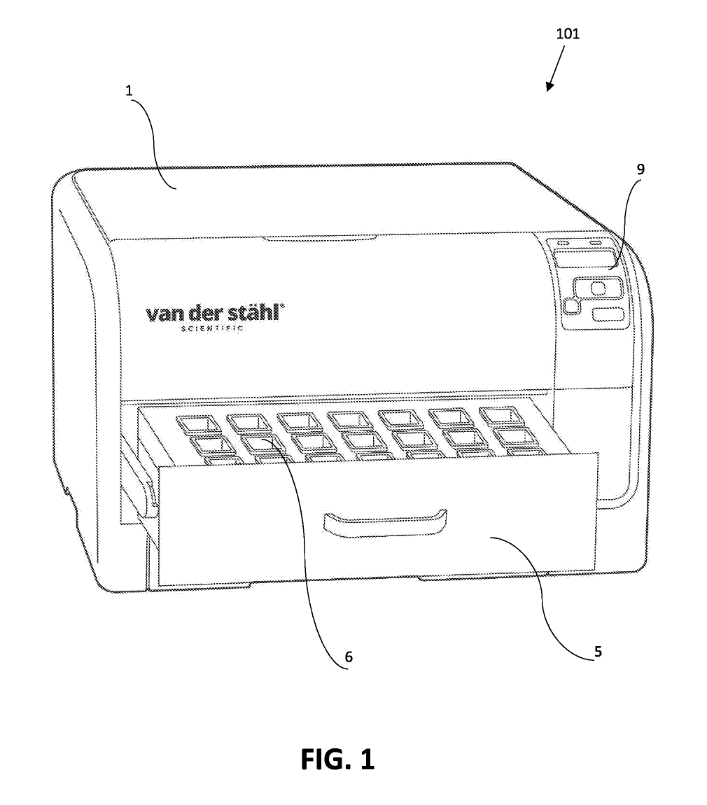

Referring to FIG. 1, a general overview of an exemplary embodiment of a device for sealing medical packages with integrated real-time seal integrity vacuum pressure decay testing in accordance with the present invention is shown. Device housing 1 houses components of the herein disclosed device 101 for sealing medical packages with integrated real-time seal integrity vacuum pressure decay testing. Door 5 may be pulled out from device housing 1 so that an operator (or a user) may load medical packages 6. Processor 9 may be supported by device housing 1. Processor 9 may be any processor, as is known in the art, capable of coordinating the sealing of medical packages 6 and the testing of the sealed medical packages. Processor 9 may be, for example, a microprocessor including an integrated circuit.

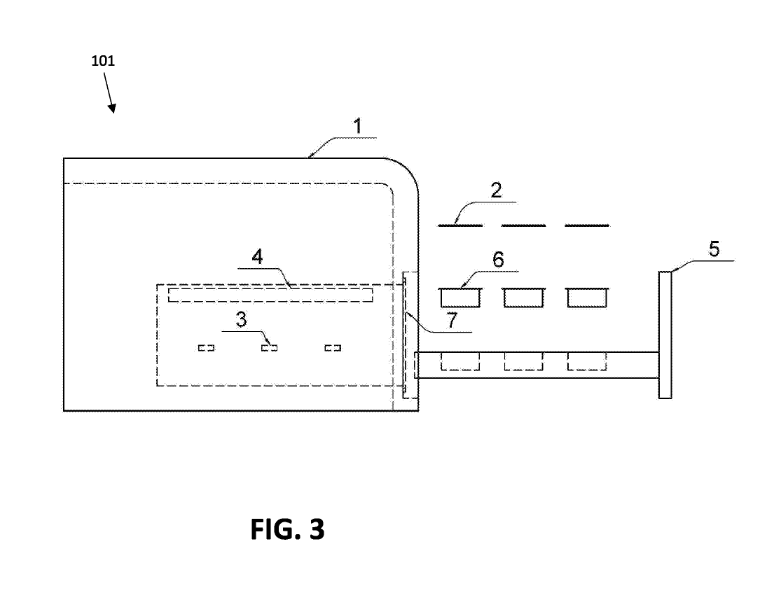

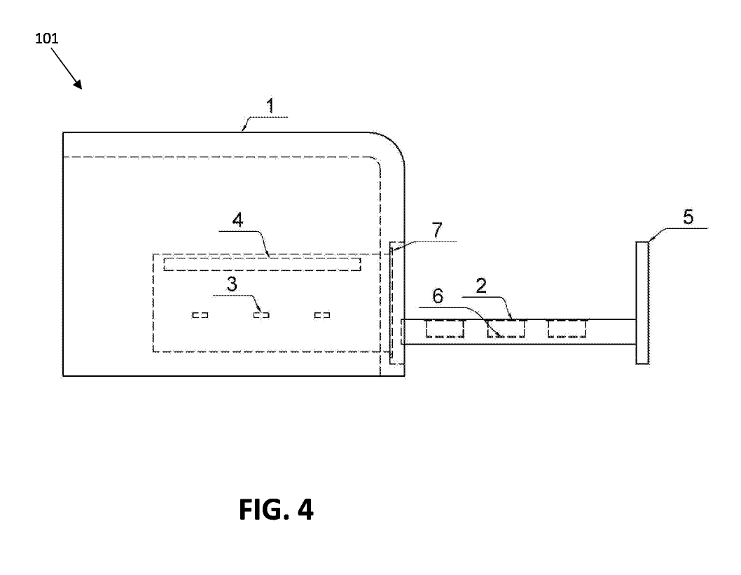

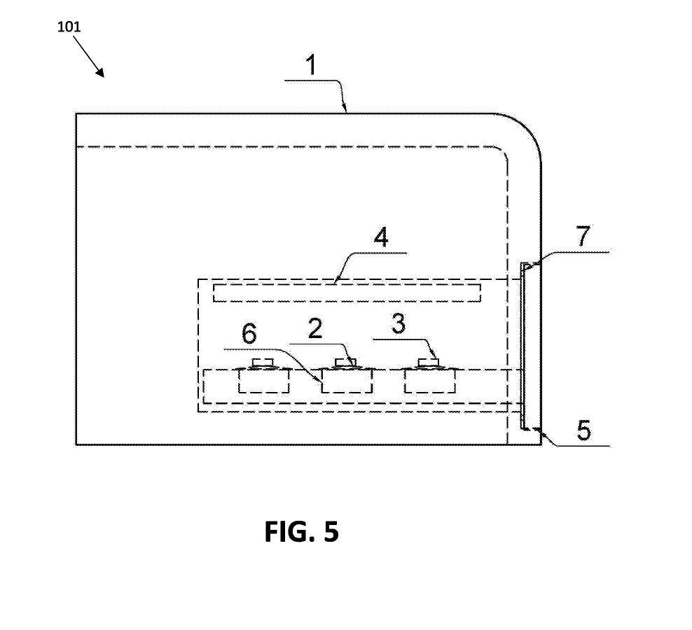

Device housing 1 of device 101 for sealing medical packages with in integrated real-time seal integrity vacuum pressure decay testing houses a medical packaging device capable of forming a seal on one or more packages by localizing heating to a temperature that melts a packaging material onto medical packages 6 to seal the medical packages 6. Such a medical packaging device, housed within device housing 1, is known in the art and any such medical packaging device, known as a sealer, may be utilized by the present invention. Referring to FIG. 3, FIG. 4, and FIG. 5, interior components of such an exemplary medical packaging device are shown, including sealer door 5, sealer door stop 7, and sealer heating element 4.

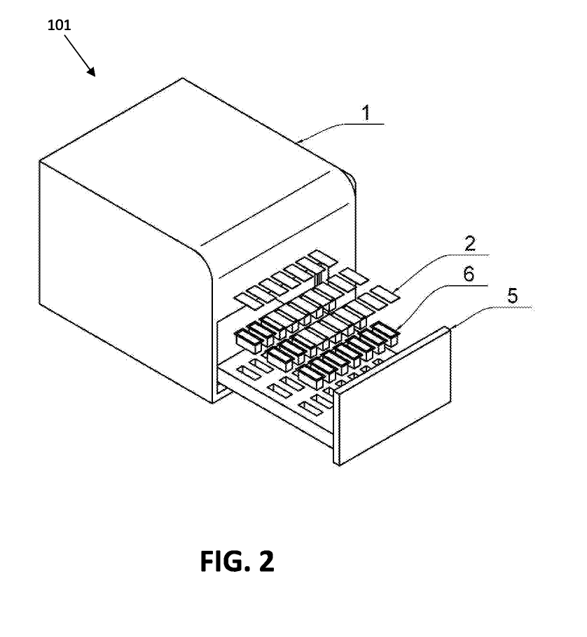

Referring to FIG. 2, an isometric view of an exemplary embodiment of a device for sealing medical packages with integrated real-time seal integrity vacuum pressure decay testing is shown as the medical packages and the packaging material are loaded into the device, in accordance with the present invention. Medical packages 6 may be loaded into slots, or holes, formed in a tray connected to sealer door 5. Packaging material 2 may be placed on top of medical packages 6, so that during a sealing step, the medical packaging device may melt the packaging material 2 to medical packages 6 to form a seal.

Referring to FIG. 3, a side view of an exemplary embodiment of device 101 for sealing medical packages with integrated real-time seal integrity vacuum pressure decay testing is shown as medical packages 6 and packaging material 2 are loaded into the device, and wherein interior structure, including sealer heating element 4 and a plurality of mass flow meters 3 comprising a pressure decay leak testing apparatus, is shown. Sealer heating element 4 may include heating dies or platen(s). A pressure decay leak testing apparatus may include one or more mass flow meters for measuring a flow of air from a surrogate chamber to the sealed medical package. Any sort of mass flow meter may be utilized herein for carrying out the pressure decay leak test on the sealed medical packages, as is known in the art of pressure decay leak testing. An exemplary embodiment of device 101 may include a plurality of mass flow meters equal to the number of medical package slots formed by the tray connected to sealer door 5. Mass flow meters 3 may be communicatively connected to processor 9 so that device 101 may analyze the results of the pressure decay leak testing.

Referring to FIG. 4, packaging material 2 may be placed above a corresponding medical package 6, so that there is one piece of packaging material for every medical package. Referring then to FIG. 5, a side view of an exemplary embodiment of device 101 for sealing medical packages with integrated real-time seal integrity vacuum pressure decay is shown after the medical packages have been sealed and while the medical packages are being pressure decay leak tested. After packaging material 2 has been melted onto medical packages 6 to form a seal, an airtight surrogate chamber may be formed within device housing 1 by sealer door 5 fitting snug against sealer door stop 7. The surrogate chamber may then be pressurized, as is known in the art of pressure decay leak testing. This specification refers to pressurizing the surrogate chamber, but it is known that an equivalent test may be performed by evacuating the surrogate chamber and evacuating is intended to be included in the use of the word pressurizing. Once the surrogate chamber is pressurized, the one or more mass flow meters 3 may measure an air flow between the surrogate chamber and the sealed medical package. The quantitative measurement of the air flow may be measured (or determined) and recorded for each medical package sealed by the herein disclosed device for sealing medical packages with integrated real-time seal integrity vacuum pressure decay testing. Each medical package may be identified with a package identification number, and each air flow recorded may be identified with a corresponding air flow identification number. The package identification number, the air flow identification number, and/or the air flow may be recorded in, or stored in, a searchable database. In this way, if at a later time there is an issue regarding one or the medical packages sealed by the herein disclosed device, the particular medical package identification number may be searched and the corresponding testing data (the pressure decay leak testing air flow quantitative measure) may be referenced.

The purpose behind integrating pressure decay testing into a device for, and method for, sealing medical packages is so that each and every medical package may be tested, and that testing data recorded, during the normal course of production (in real-time, in other words). The fact that pressure decay leak testing is non-destructive and does not require direct light (as visual testing requires) means that pressure decay leak testing may be built into the housing of a sealer device, as is disclosed herein. By communicatively coupling the mass flow meter(s) to the processor of the herein disclosed device, each sealed package may be tested for a quantitative measure of air flow, and the quantitative measure of air flow may be recorded and stored in a searchable database. In this way, 100% of the medical packages sealed may be inspected for deviation from an established standard. For example, a government may dictate that any air flow above 0.001 kilograms per second does not meet the government's standards and thus the corresponding medical package may not be sold (or used with or on a patient). In this case, compliance would be defined as any air flow below the government established maximum air flow. The government dictated maximum air flow is an example of a criterion that may be used to determine if the sealed medical package is satisfactory. Industry standards may also dictate compliance, and may dictate a maximum air flow or other criterion for the sealed medical packages. The phrase “government mandated standard” is intended to include one or more industry standards, such as those issued by ISO (International Organization for Standardization) for example.

If the present invention determines that there is a non-compliant medical package, a notification may be displayed or sent (to an operator, for example); alternatively, the herein disclosed device may stop operation and/or notify an operator when a defective seal integrity (as defined by the air flow compared to the government dictated maximum air flow) is recognized by the processor. For example, a notification may be displayed on the systems onboard microprocessor, the identified package failure will evoke an audible and/or visual alarm and will stop system operation, preventing the failed package from entering into the distribution chain of sterile medical devices. The device may also, for example, record the failure event on the system onboard memory for data purge at a later time or the system can stream data via Wi-Fi.

The present invention has been described in terms of a device for sealing packages and testing a seal integrity of the sealed packages. But the present invention may also be described as a method for sealing and testing medical packages, as will be apparent to those skilled in the art. The methods associated with the present invention include the steps of: sealing one or more packages by localized heating to a temperature that melts the one or more packages; testing the one or more packages by pressure decay leak testing; recording an air flow for each of the one or more packages; comparing the air flow for each of the one or more packages to a predetermined compliance standard air flow; indicating if one or more of the packages is not in compliance; and identifying one or more non-compliance packages.

While the present invention has been illustrated and described herein in terms of a preferred embodiment and several alternatives, it is to be understood that the systems and methods described herein can have a multitude of additional uses and applications. Accordingly, the invention should not be limited to just the particular description and various drawing figures contained in this specification that merely illustrate a preferred embodiment and application of the principles of the invention.

What is claimed is:

1. A device for sealing packages and testing seal integrity of sealed packages comprising:
a device housing;
a medical packaging device supported by the system housing, the medical packaging device forming a seal on one or more packages by localized heating to a temperature that melts the one or more packages;
a pressure decay leak testing apparatus for testing a seal integrity of the one or more packages;
a processor supported by the device housing and coordinating with the medical packaging device and the pressure decay leaking testing apparatus;
wherein the processor analyzes the seal integrity to ascertain whether the seal integrity satisfies a predetermined criterion.

2. The device as recited in claim 1, wherein testing a seal integrity of the one or more packages includes determining an air flow between a surrogate chamber and the one or more packages and recording the air flow for each of the one or more packages.

3. The device as recited in claim 2, wherein the processor analyzes the seal integrity to determine whether the seal integrity satisfies a predetermined criterion by comparing the air flow for each of the one or more packages to the predetermined criterion.

4. The device as recited in claim 1, wherein the medical packaging device stops operation and notifies an operator when a defective seal integrity is recognized by the processor.

5. The device as recited in claim 1, wherein the predetermined criterion is a government mandated standard.

6. The device as recited in claim 2, wherein each of the one or more packages has a package identification number and wherein the air flow for each of the one or more packages has a corresponding air flow identification number.

7. The device as recited in claim 6, wherein each of the package identification numbers and the corresponding air flow identification numbers are stored in a searchable database.

8. A method for sealing and testing medical packages, comprising the steps of:
sealing one or more packages by localized heating to a temperature that melts the one or more packages;
testing the one or more packages by pressure decay leak testing;
recording an air flow for each of the one or more packages;
comparing the air flow for each of the one or more packages to a predetermined compliance standard airflow;
indicating if one or more packages is not in compliance; and
identifying one or more non-compliance packages.

9. A device for sealing packages and testing seal integrity and seal strength of sealed packages comprising:
a device housing;
a medical packaging device supported by the system housing, the medical packaging device forming a seal on one or more packages;
a vacuum decay or pressure differential testing apparatus for testing a seal integrity and a seal strength of the one or more packages;
a processor supported by the device housing and coordinating with the medical packaging device and the vacuum decay or pressure differential testing apparatus;
wherein the processor analyzes the seal integrity and the seal strength to ascertain whether the seal integrity and seal strength satisfies a predetermined criterion.
